(19) United States
(12) Patent Application Publication
(10) Pub. No.: US 2007/0206938 A1
(43) Pub. Date: Sep. 6, 2007

(54) Distance measuring apparatus and method

(75) Inventor: Hiroshi Tanaka, Tokyo (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/712,406

(22) Filed: Mar. 1, 2007

(30) Foreign Application Priority Data
Mar. 2, 2006 (JP) 055739/2006

(51) Int. Cl. G03B 13/00

(52) U.S. Cl. 396/106

(57) ABSTRACT

In an imaging device that performs pre-emission of strobe light prior to imaging, image data of a subject is obtained while the pre-emission is performed, and a target object is detected from the obtained image data. Then, a determination is made whether the luminance and/or gradation of the detected target object is less than or equal to a predetermined threshold value. If it is determined to be less than or equal to the predetermined threshold value, AF auxiliary light is irradiated toward the target object, and the distance to the target object is measured while the irradiation of AF auxiliary light is performed.

### BACKGROUND OF THE INVENTION

1. Field of the Invention

The present invention relates to a distance measuring apparatus and a distance measuring control method applicable to a digital still cameras and the like having a distance measuring function.

2. Description of the Related Art

Automatic focusing (AF) mechanisms have been widely use in imaging devices, such as digital cameras, digital video cameras, and the like. The AF function causes the taking lens to be focused on a predetermined subject. This type of AF mechanisms include the active system in which the distance from the imaging device to the subject is measured by irradiating infrared light from the imaging device to the subject, and detecting the angle of the infrared light reflected back to the imaging device, and the position of the taking lens is set so as to be focused on the object at the measured distance, and the passive system in which the focusing status is detected by processing the image signals outputted from the imaging means of an imaging device, and the taking lens is placed at a position where best focus is obtained.

The passive AF mechanisms which are widely known in the art are: the phase detection system in which the focusing status is determined from the amount of lateral displacement, and the contrast detection system in which the focusing status is determined from the contrast of the image. In the contrast detection AF mechanism, the taking lens is moved in a stepwise manner within the working range of focusing (e.g., from the nearest to farthest), and image data are obtained from the imaging means every time the taking lens is moved stepwise, thereby the taking lens is placed at a position corresponding to a maximum focus evaluation value (contrast value) of the obtained image data.

The contrast detection system, however, has a drawback that it is difficult to measure the distance to the target object, and to determine the position of the taking lens for focusing when the subject has a low focus evaluation value or the subject is dark, so that the subject is sometimes out of focus. Consequently, a method in which AF auxiliary light is irradiated on a subject to increase the focus evaluation value of the subject is employed. Further, a method for controlling the amount of light of the AF auxiliary light according to the imaging environment for the subject is also proposed as described, for example, in Japanese Unexamined Patent Publication No. 2000-121924.

The AF auxiliary light, however, needs to be emitted for a relatively long time, unlike the strobe light which is irradiated toward a wide area in a short time. Therefore, the AF auxiliary light is irradiated toward a selected narrow area, taking into account the power consumption. Accordingly, if the coverage of the AF auxiliary light is out of the target object, it is difficult to obtain an accurate focus evaluation value, which may result in an inaccurate distance measurement for the target object.

### SUMMARY OF THE INVENTION

The present invention has been developed in view of the circumstances described above, and it is an object of the present invention to provide a distance measuring apparatus and a distance measuring method capable of accurately measuring the distance to a target object by reliably irradiating AF auxiliary light thereto.

The distance measuring apparatus of the present invention is an apparatus to be mounted on an imaging device having a strobe emission means for emitting strobe light toward a subject at the time of imaging, and a strobe control means for causing the strobe emission means to perform pre-emission of the strobe light toward the subject prior to imaging, the apparatus including:

an obtaining means for obtaining image data of the subject while the pre-emission caused by the strobe control means is performed;

a detection means for detecting a predetermined target object from the image data obtained by the obtaining means;

a determining means for determining whether the luminance and/or gradation of the region of the predetermined target object detected by the detection means is less than or equal to a predetermined threshold value;

an auxiliary light irradiation means for irradiating AF auxiliary light toward the predetermined target object when the luminance and/or gradation of the region of the predetermined target object detected by the detection means is determined by the determination means to be less than or equal to the predetermined threshold value; and

a distance measuring means for measuring the distance to the predetermined target object while the irradiation of AF auxiliary light is performed by the auxiliary light irradiation means.

In the distance measuring apparatus of the present invention, it is preferable that the predetermined target object be a face or an eye.

Preferably, the auxiliary light irradiation means of the distance measuring apparatus of the present invention is a means that irradiates the AF auxiliary light toward an area of the face lower than the center or the eyes thereof.

The distance measuring method of the present invention is a method to be employed in an imaging method in which pre-emission of strobe light toward a subject is performed by a strobe emission means prior to imaging, the distance measuring method including the steps of:

obtaining image data of the subject while the pre-emission is performed;

detecting a predetermined target object from the obtained image data;

determining whether the luminance and/or gradation of the region of the detected predetermined target object is less than or equal to a predetermined threshold value;

irradiating AF auxiliary light toward the predetermined target object if the luminance and/or gradation of the region of the detected predetermined target object is determined to be less than or equal to the predetermined threshold value; and

measuring the distance to the predetermined target object while the irradiation of AF auxiliary light is performed.

According to the distance measuring apparatus and distance measuring method of the present invention, pre-emission of strobe light is performed toward a subject by a strobe emission means prior to imaging, image data of the subject is obtained while the pre-emission is performed, and a predetermined target object is detected from the obtained image data. This allows the target object to be detected after the luminance of the target object is increased by the pre-emission when the target object has a low luminance value, so that the target object may be detected reliably.

Further, a determination is made whether the luminance and/or gradation of the region of the detected predetermined target object is less than or equal to a predetermined threshold value. If the luminance and/or gradation of the region of the detected predetermined target object is determined to be less than or equal to the predetermined threshold value, AF auxiliary light is irradiated toward the predetermined target object, and the distance to the predetermined target object is measured while the irradiation of AF auxiliary light is performed. Thus, even if the region of the predetermined target object has a low luminance and/or gradation value, the luminance and/or the gradation of the region of the predetermined target object is increased by the irradiation of the AF auxiliary light, so that an accurate focus evaluation value may be obtained, and hence the distance to the predetermined target object may be measured accurately.

Further, if the predetermined target object is a face or an eye, and AF auxiliary light is irradiated toward an area of the face lower than the center or the eyes thereof, the target object is protected from the glare of the AF auxiliary light.

### BRIEF DESCRIPTION OF THE DRAWINGS

FIG. 1 is a rear view of a digital camera.

FIG. 2 is a front view of the digital camera

FIG. 3 is a functional block diagram of the digital camera.

FIG. 4 is a graph illustrating an example distribution of focus evaluation values at respective positions of a focus lens for performing focusing operation.

FIG. 5 is a flowchart illustrating a process sequence of the digital camera.

FIG. 6 is a flowchart illustrating an imaging condition setting process.

FIGS. 7A and 7B are drawings for comparing the distance measuring apparatus of the present invention with a conventional distance measuring apparatus.

### DESCRIPTION OF THE PREFERRED EMBODIMENTS

Hereinafter, the distance measuring apparatus according to an embodiment of the present invention will be described in detail with reference to accompanying drawings. In the embodiment, a digital camera will be described as an electronic device having the distance measuring apparatus as an example case. But it will be appreciated that the application scope of the present invention is not limited to this, and the present invention is applicable to other electronic devices having electronic imaging functions, such as cell phones with camera functions, PDAs with camera functions, and the like.

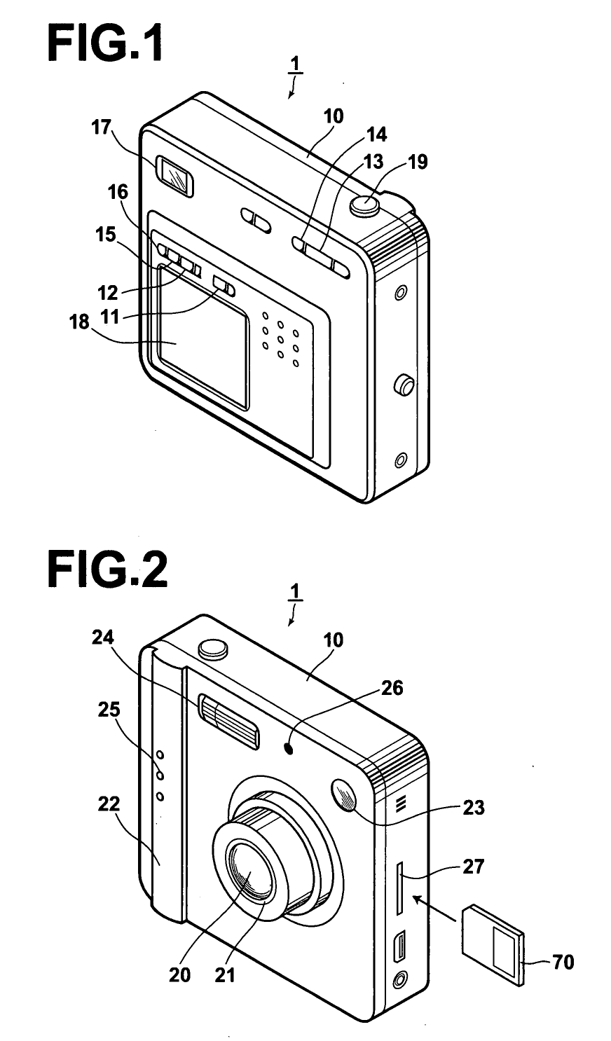

FIGS. 1 and 2 illustrate an example digital camera. FIG. 1 is an external view thereof viewed from the rear side, and FIG. 2 is an external view thereof viewed from the front side. An operation mode switch 11; a menu/OK button 12; a zoom/up-down lever 13; a right-left button 14; a back (return) button 15; display switching button 16; a finder 17 for imaging; a monitor 18 for imaging and playback; and a shutter button 19 are provided on the rear side of the main body 10 of the digital camera 1 as the operation interface for the user as shown in FIG. 1.

The operation mode switch is a slide switch for performing switching among still image recording mode, moving picture imaging mode, and playback mode. The menu/OK button 12 is a button for selecting imaging mode, strobe emission mode, or displaying various menus on the monitor 18 for setting the number of recording pixels, sensitivity and the like, which are sequentially selected by depressing the button, and also for determining the selection/setting based on the menu displayed on the monitor 18.

The zoom/up-down lever 13 is moved in up/down directions when performing telescope/wide angle control at the time of imaging, and performing cursor control on the menu screen displayed on the monitor 18 at the time of performing various settings. The right-left button 14 is used for moving the cursor in right/left directions on the menu screen displayed on the monitor 18 at the time of performing various settings.

The back (return) button 15 is depressed when terminating the various settings and displaying an immediately preceding screen on the monitor 18. The display switching button 16 is depressed when performing display ON/OFF switching of the monitor 18, displaying various guidance, performing character display ON/OFF switching, and the like. The finder 17 is provided for the user for viewing and verifying the image composition and focus when imaging of a subject is performed by the user. The subject image viewed through the finder 17 is provided through a finder window 23 provided on the front side of the main body 10.

The setting contents of each of the buttons and levers described above may be confirmed by a display on the monitor 18, a lamp within the finder 17, the position of the slide levers, or the like. Further, when performing imaging, a through image for confirming the subject is displayed on the monitor 18. Thus, the monitor functions as an electronic view finder, as well as the functions of displaying a playback still image or a moving image after imaging, and displaying various set menus. When the shutter button 19 is operated by the user, an imaging is performed based on the determined exposure and focus position, and the image displayed on the monitor 18 is recorded.

As shown in FIG. 2, a taking lens 20, a lens cover 21, a power switch 22, the finder window 23, a strobe light 24, a self-timer lamp 25, and an AF auxiliary lamp 26 are provided on the front side of the main body 10, with a media slot 27 on a lateral side thereof.

The taking lens 20 is a lens for focusing a subject on a predetermined imaging surface (e.g., CCD provided inside of the main body 10, or the like), and includes a focus lens, a zoom lens, and the like. The lens cover 21 is provided for covering the surface of the taking lens 20 to protect the lens 20 from contamination, dust, and the like when the digital camera is inactivated, in playback mode, or the like. The power switch 22 is a switch for turning on and off the power of the digital camera 1. The strobe light 24 is provided for instantaneously irradiating light required for imaging to the subject when the shutter button 19 is depressed and while the shutter provided inside of the main body is opened. The self-timer lamp 25 is provided for notifying the timing of open/close of the shutter when performing imaging using the self-timer. The AF auxiliary light 26 includes, for example, an LED, and is provided for facilitating AF processing, to be described later, by irradiating narrow range light, i.e., focused light for a prolonged time. The media slot 27 is provided for inserting an external recording medium 70, such as a memory card, or the like. When the external recording medium 70 is inserted therein, data read/write operation is performed.

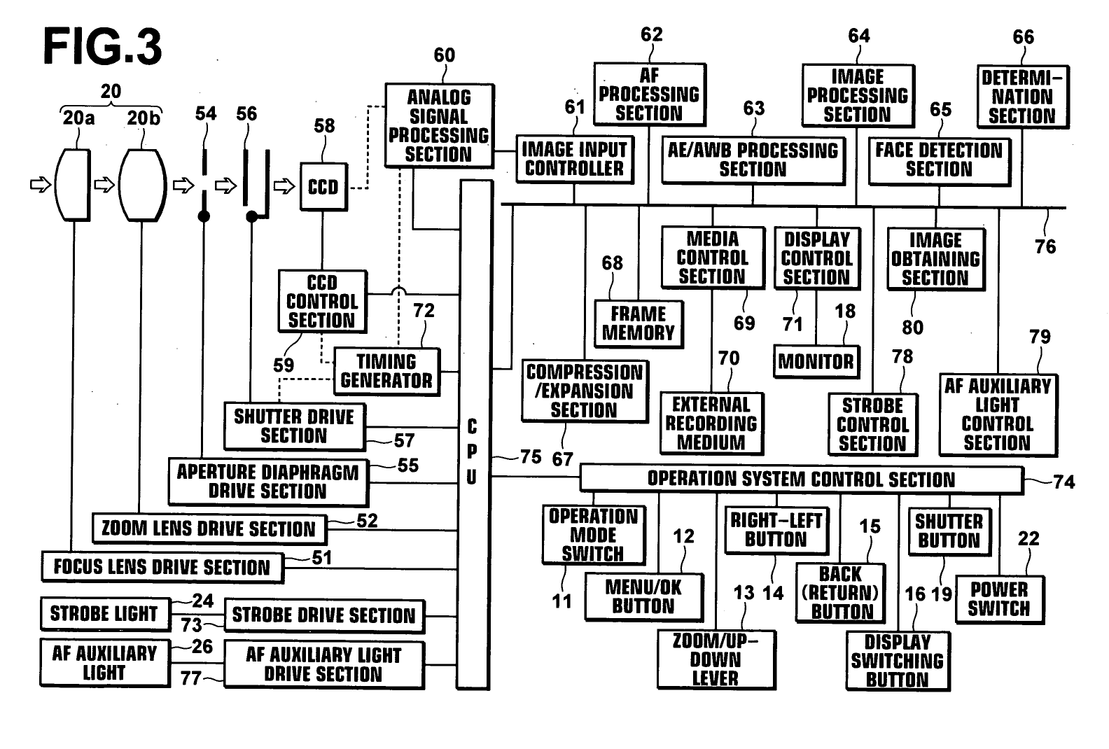

FIG. 3 is a functional block diagram of the digital camera 1. The digital camera 1 includes: the operation mode switch 11; the menu/OK button 12; the zoom/up-down lever 13; the right-left button 14; the back (return) button 15; the display switching button 16; the shutter button 19; and the power switch 22 as the operation system thereof, in addition to an operation system control section 74 as shown in FIG. 3.

The taking lens 20 includes a focus lens 20a and a zoom lens 20b. The lenses 20a and 20b are movable in the optical axis directions through step driving by a focus lens drive section 51 and zoom lens drive section 52 respectively, each of which including a motor and a motor driver. The focus lens drive section 51 step drives the focus lens 20a based on focus drive amount data outputted from an AF processing section 62. The zoom lens drive section 52 controls the step driving of the zoom lens 20b based on operated amount data of the zoom/up-down lever 13.

An aperture diaphragm 54 is driven by an aperture diaphragm drive section 55 that includes a motor and a motor driver. The aperture diaphragm drive section 55 regulates the aperture diameter of the aperture diaphragm based on aperture value data outputted from an AE (Automatic Exposure)/AWB (Automatic White Balance) processing section 63.

A shutter 56 is a mechanical shutter, and is driven by a shutter drive section 57 which includes a motor and a motor driver. The shutter drive section 57 performs open/close control of the shutter 56 based on a depressed signal of the shutter 19 and shutter speed data outputted from the AE/AWB processing section 63.

A CCD 58, the image sensor of the digital camera 1, is provided on the rear side of the optical system described above. The CCD 58 has a photoelectric surface that includes multitudes of light receiving elements disposed in a matrix form, and the subject image transmitted through the optical system is focused on the photoelectric surface and subjected to a photoelectric conversion. A microlens array (not shown) for directing light to respective pixels, and a color filter array (not shown) including R, G, and B filters arranged regularly are disposed in front of the photoelectric surface. The CCD 58 reads out charges stored in the respective pixels line by line in synchronization with a vertical transfer clock signal and a horizontal transfer clock signal supplied from a CCD control section 59, and outputs the charges as image signals. The charge storage time of each pixel (exposure time) is determined by an electronic shutter drive signal supplied from the CCD control section 59.

The image signals outputted from the CCD 58 are inputted to an analog signal processing section 60. The analog signal processing section 60 includes: a correlated double sampling circuit (CDS) for removing noise from the image signals; an automatic gain controller (AGC) for regulating the gain of the image signals; and an A/D converter (ADC) for converting the image signals to digital image data. The digital image data are CCD-RAW data in which each pixel has RGB density values.

A timing generator 72 is provided for generating timing signals, which are inputted to the shutter drive section 57, CCD control section 59, analog signal processing section 60, thereby the operation of the shutter button 19, open/close of the shutter 56, charge acquisition of the CCD 58, and the processing of the analog signal processing section 60 are synchronized.

A strobe drive section (strobe emission means) 73 causes the strobe light 24 to emit light based on a signal from a strobe control section (strobe control means) 78, to be described later. More specifically, if forced mode or automatic mode is selected as the strobe emission mode, and a pre-image, to be described later, is darker than a predetermined brightness, the strobe light 24 is turned on and caused to emit light therefrom when imaging. On the other hand, if inhibit mode is selected as the strobe emission mode, light emission from the strobe light 24 is inhibited at the time of imaging. This will be described in more detail later.

An AF auxiliary light drive section (auxiliary light irradiation means) 77 causes the AF auxiliary light 26 to emit light based on a signal from an AF auxiliary light control section 79, to be described later.

An image input controller 61 writes the CCD-RAW data inputted from the analog signal processing section in a frame memory 68. The frame memory 68 is a work memory used when various types of digital image processing (signal processing) are performed, and may be, for example, a SDRAM (Synchronous Dynamic Random Access Memory) that performs data transfer in synchronization with a bus clock signal having a constant frequency.

A display control section 71 is provided for causing the monitor 18 to display the image data stored in the frame memory as a through image. For example, the display control section 71 combines a luminance (Y) signal and a color (C) signal into a single composite signal, and outputs the composite signal to the monitor 18. Through images are obtained at predetermined time intervals and displayed on the monitor 18 while the imaging mode is selected. In addition, the display control section 71 causes the monitor 18 to display an image which is based on image data included in the image file stored in the external recording medium 70 and read out by a media control section 69.

A face detection section (detection means) 65 is provided for detecting a face or an eye of a person from the image data stored in the frame memory 68. In the present embodiment, description will be made, hereinafter, of a case in which a face of a person is detected, but a configuration may be adopted in which an eye of a person, or a face or an eye of an animal is detected. As for the face detection, conventional methods as described, for example, in Japanese Unexamined Patent Publication Nos. 2004-320286 and 2005-242640 may be used.

A determination section (determination means) 66 determines whether the luminance (EV value) and/or gradation is lower than or equal to a predetermined threshold value. The predetermined threshold value may be represented by a value obtained by combining a full open aperture value (AV value), which is the brightness when the aperture diaphragm 54 is fully opened, with a camera shake threshold shutter speed (TV value).

When the luminance of the subject (EV value) is determined by the determination section 66 to be lower than or equal to the predetermined threshold value, a strobe control section (strobe control means) 78 drive controls the strobe drive section 73 so that a pre-emission of the strobe light 24 occurs toward the subject.

When the luminance of a face region detected by the face detection section 65 is determined by the determination section 66 to be lower than or equal to a predetermined threshold value, the AF auxiliary light control section (auxiliary light irradiation means) 79 drive controls the AF auxiliary light drive section 77 so that the AF auxiliary light 26 is irradiated toward the face. Here, control may be performed to cause the AF auxiliary light 26 to be irradiated toward the face area lower than the center thereof, for example, toward the chin. This may prevent the glare for the person.

An image obtaining section (obtaining means) 80 obtains image data of the subject during the pre-emission of the strobe light 24 caused by the strobe control section 78.

The AF processing section (distance measuring means) 62, and the AE/AWB processing section 63 determine imaging conditions based on a pre-image. The pre-image is an image based on the image data stored in the frame memory 68 as a result of pre-imaging performed by the CCD 58, which is caused by a CPU 75 that detects a halfway depressed signal generated when the shutter button 19 is depressed halfway.

The AE/AWB processing section 63 measures the luminance of the subject based on the pre-image, and determines the aperture value, shutter speed, and the like to output aperture value data and shutter speed data (AE), as well as automatically regulating the white balance at the time of imaging (AWB).

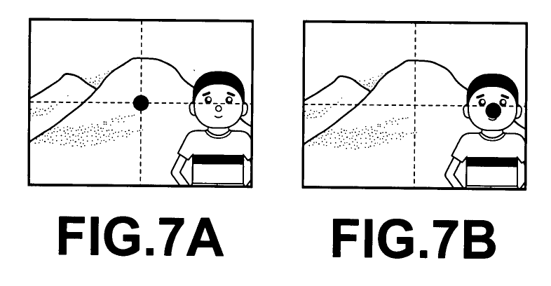

The AF processing section 62 measures the distance, i.e., detects focus position based on the pre-image, and outputs focus drive section data. The distinctive feature of the present invention is that, when the luminance of the face region detected by the face detection section 65 is determined by the determination section 66 to be lower than or equal to a predetermined threshold value, the AF auxiliary light 26 is irradiated toward the face, and the distance to the face region is measured while the AF auxiliary light 26 is irradiated thereon. FIGS. 7A, 7B are drawings for comparing the distance measuring apparatus of the present invention with a conventional distance measuring apparatus.

As shown in FIG. 7A, the coverage of the AF auxiliary light is conventionally limited, and the AF auxiliary light is irradiated on the central region of the pre-image. Thus, if the target face region for AF processing locates other than the central region, the AF auxiliary light does not sufficiently reach the face region. On the other hand, in the present invention, the AF auxiliary light is irradiated toward the face region as shown in FIG. 7B, so that a sufficient amount of the light may reach the face region and the luminance of the face region is increased. Here, the AF auxiliary light is irradiated toward an area of the face lower than the center or the eyes thereof, such as the chin, so that the AF auxiliary light is not directed, in particular, to the eyes in order to prevent the glare for the person.

In the mean time, as a method for detecting the focus position described above, the passive system is applied, which makes use of the fact that the focus evaluation value (contrast value) of an image becomes high when focused. The AF processing in which focus evaluation values are calculated using the AF processing section 62 and the like to determine the focus position will now be described in detail.

First, the focus lens 20a is moved by the focus lens drive section 51 in the optical axis directions over the entire working range for focusing based on the drive data outputted from the AF processing section 62. In the present embodiment, the working range for focusing (search range) is, as an example, from 60 cm on the nearest side to infinity on the farthest side in which an object may be focused. While the focus lens 20a is moved in the manner as described above, the pre-imaging is performed by the CCD 58, and the obtained image data are stored in the frame memory 68. The pre-imaging is performed at each predetermined position of the focus lens 20a moved in a stepwise manner, and a focus evaluation value at each lens position is obtained by the AF processing section 62 based on the contrast of the face region of the recorded image. The AF processing section 62 performs filtering on the image data representing the image to extract high frequency components thereof, and obtains the focus evaluation value by integrating the absolute values of the high frequency components. Here, if the luminance of the face region is determined by the determination section 66 to be less than or equal to a predetermined threshold value, the AF auxiliary light 26 is irradiated toward the face region as described above. Therefore, even when the face region has a low luminance and/or gradation value, the luminance of the face region is increased by the irradiation of the AF auxiliary light 26. Thus, an accurate focus evaluation value may be obtained.

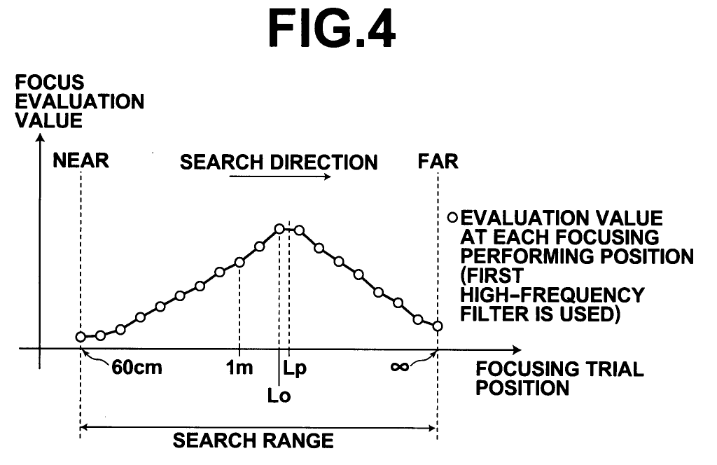

An example of the focus evaluation values at the respective positions for performing focusing operation within the working range for focusing is illustrated in FIG. 4.

Then, the focus position is determined. The AF processing section 62 obtains a position Lp where the focus evaluation value takes a peak value by an interpolation method or the like based on the characteristics like that shown in FIG. 4 and the position Lp is determined as the focus position. Alternatively, the peak position may be determined as the position that takes a maximum value among the actually obtained focus evaluation values, and if such maximum value is obtained at two positions, the position on the nearest side is determined as the peak position (Lo in the example shown in FIG. 4), or the like.

Movement of the focus lens 20a over the entire working range for focusing is not necessarily required. For example, if “climbing focusing operation” as described, for example, in Japanese Unexamined Patent Publication No. 2004-048446 is employed, the focus lens 20a is required to be moved only within a portion of the entire working range for focusing. This allows faster focusing operation.

When the focus position is determined in the manner as described above, the focus lens 20a is fixed at the focus position. That is, the focus lens 20a is moved to the focus position and stopped thereat by the focus lens drive section 51 based on the focus drive amount data outputted from the AF processing section 62. In this way, the AF processing is performed.

The image processing section 64 performs image quality corrections, such as gamma correction, sharpness correction, contrast correction, and the like on the image data of a final image. In addition, it performs YC processing in which CCD-RAW data are converted to Y data, which are luminance signal data, and YC data that include Cb data, which are blue chrominance difference signals, and Cr data, which are red chrominance difference signals. The referent of “final image” as used herein means an image based on the image data stored in the frame memory 68 which are obtained by the CCD 58 when the shutter button is fully depressed and outputted therefrom as image signals and stored in the frame memory through the analog signal processing section 60 and the image input controller 61. The upper limit of the number of pixels of the final image is dependent on the number of pixels of the CCD 58. But the number of pixels for recording may be changed, for example, by image quality setting allowed to the user (fine, normal, or the like). In the mean time, the number of pixels for a through image or a pre-image may be less than that of a final image, e.g., 1/16 of the final image.

A compression/expansion section 67 generates an image file by performing compression, for example, in JPEG format on the image data after processed by the image processing section 64 for image quality corrections. Tag information is added to the image file based on various data formats. Further, the compression/expansion section 67 reads out a compressed image file from the external recording medium 70 and performs expansion thereon in the playback mode. The expanded image data are outputted to the display control section 71, which causes the monitor 18 to display an image based on the image data.

The media control section 69 corresponds to the media slot 27 in FIG. 2, and reads out an image file or the like recorded on the external recording medium 70, or writes an image file thereon.

The CPU 75 controls each section of the main body of the digital camera 1 in response to the signals from various buttons, levers, switches, and each of the functional blocks. A data bus 76 is connected to the image input controller 61, various processing sections 62 to 64, and 67, face detection section 65, determination section 66, frame memory 68, various control sections 69, 71, 78, and 79, image obtaining section 80, and CPU 75, and various signal and data transmission and reception are performed through the data bus 76.

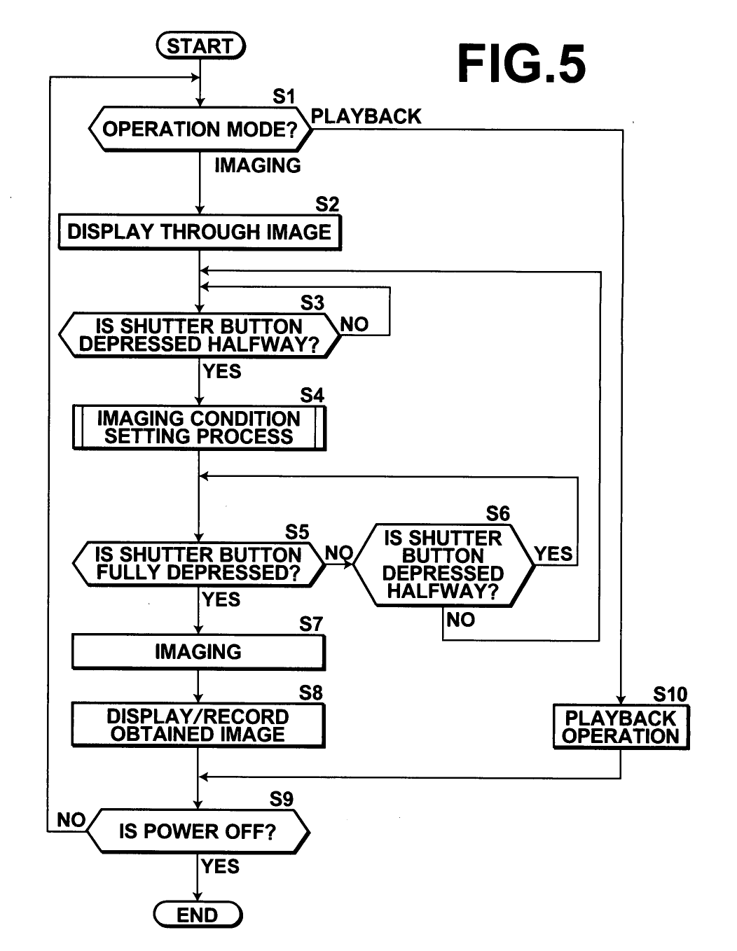

A process sequence performed at the time of imaging in the digital camera 1 constructed in the manner as describe above will now be described. FIG. 5 is a flowchart illustrating a process sequence of the digital camera 1. As shown in FIG. 5, a determination is made by the CPU 75 whether the operation mode is imaging mode or playback mode according to the setting of the operation mode switch 11 (step S1). If the operation mode is playback mode (step S1: Playback), playback operation is performed (step S10). In the playback operation, an image file is read out by the media control section 69 from the external recording medium 70, and an image based on the image data included in the image file is displayed on the monitor 18. When the playback operation is completed, a determination is made by the CPU 75 whether deactivation operation is performed by the power switch 22 of the digital camera 1 (step S9). If the determination result is positive (step S9: Yes), the power of the digital camera 1 is turned off and the process is terminated.

In the mean time, if the operation mode is determined to be imaging mode in step S1 (step S1: Imaging), display control of a through image is performed by the CPU 75 (step S2). The display of the through image means that the pre-image described above is displayed on the monitor 18. Then, a determination is made by the CPU 75 whether the shutter button 19 is depressed halfway (step S3). If the determination result is negative (step S3: No), the processing in step S3 is repeated by the CPU 75. If the determination result is positive (step S3: Yes), an imaging condition setting process is performed (step S4).

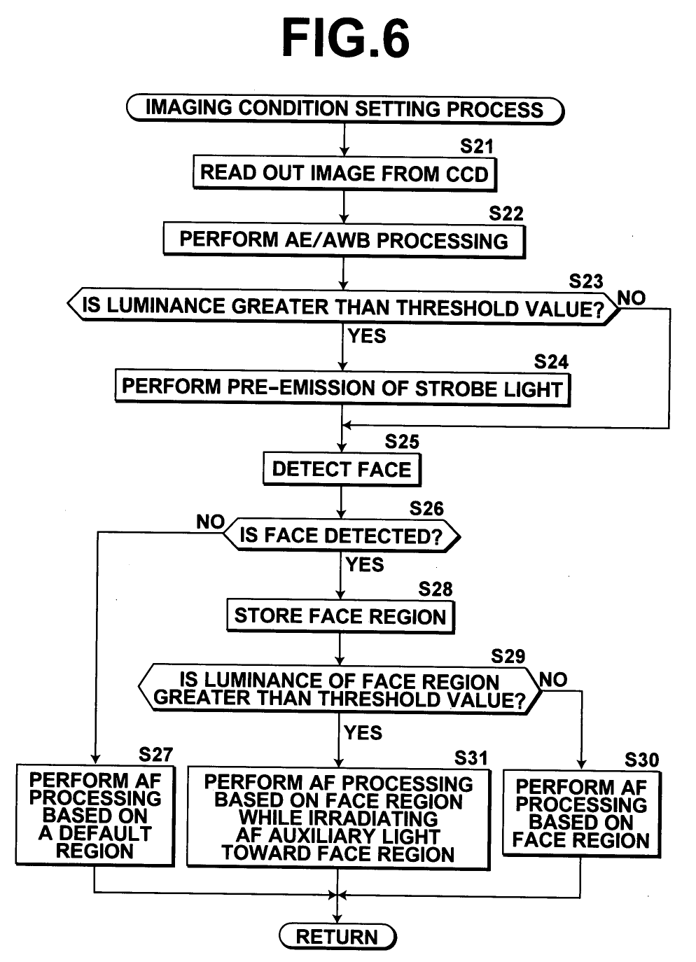

FIG. 6 is a flowchart illustrating the imaging condition setting process. As shown in FIG. 6, pre-image data obtained by the CCD 58 through pre-imaging and stored in the frame memory 68 are readout (step S21). Then, based on the obtained pre-image, AE/AWB processing is performed by the AE/AWB processing section 63 (step S22).A determination is made by the determination section 66 whether the luminance of the subject (EV value) measured by the AE/AWB processing section 63 based on the pre-image is lower than or equal to a predetermined threshold value, i.e., whether the pre-image has predetermined brightness (step S23). If the determination result is positive (step S23: Yes), the strobe light 24 is pre-emitted toward the subject from the strobe control section 78 (step S24).

The image data of the subject is obtained by the image obtaining section 80 while the pre-emission of the strobe light is performed, and a face is detected by the face detection section 65 from the obtained image data (step S25). In this way, even when the subject has a low luminance value, the face of the subject is detected after the luminance of the subject is increased by the pre-emission. This allows the face to be detected reliably. If the brightness of the subject is higher than the predetermined threshold value in step S23, i.e., the subject has a predetermined brightness (step S23: No), the process is advanced to step S25 by the CPU 75.

If no face is detected (step S26: No), the AF processing is performed by the AF processing section 62 according to a default region. If a face is detected (step S26: Yes), the region of the face is stored, for example, in a not-shown storage section (step S28), and a determination is made by the determination section 66 whether the luminance (EV value) of the face region is less than or equal to a predetermined threshold value, i.e., the face region has a predetermined brightness value (step S29). If the determination result is negative (step S29: No), the AF processing is performed by the AF processing section 62 based on the face region (step S30).

If the determination result is positive (step S29: Yes), the AF auxiliary light drive section 77 is controlled by the AF auxiliary light control section 79 so that the AF auxiliary light 26 is irradiated toward the face, and the AF processing is performed by the AF processing section 62 based on the face region while the AF auxiliary light 26 is irradiated thereon (step S31).

In this way, even when the face region has a low luminance value, the luminance of the face region is increased by the irradiation of the AF auxiliary light, so that an accurate focus evaluation value may be obtained. This allows an accurate distance measurement for the face region. After the imaging conditions are set in the manner as described above, the process returns to FIG. 5.

After the imaging condition setting process is completed (step S4), a determination is made whether the shutter button 19 is fully depressed (step S5). If the determination result is negative (step S5: No), a determination is made by the CPU 75 whether the shutter button is depressed halfway (step S6). If the determination result is negative (step S6: No), the process is returned to step S3, and if the determination result is positive (step S6: Yes) the process is returned to step 5S by the CPU 75. Further, if the shutter button 19 is fully depressed (step S5: Yes), imaging operation is performed by the CPU 75 (step S7) according to the imaging conditions determined by the imaging condition setting process (step S4). The referent of “imaging operation” as used herein means processing in which analog image data based on a subject image focused on the photoelectric surface of the CCD 58 are A/D converted, and various signal processing is performed thereon by the image processing section 64. Further, the imaging operation may include the compression/expansion by the compression/expansion section 67 on the processed image data to generate an image file.

After the imaging operation is completed, the processing for displaying the recorded image on the monitor 18 or recording the image on the external recording medium 70 is performed by the CPU 75 (step S8). Then, a determination is made by the CPU 75 whether deactivation operation is performed through the power switch 22 (step S9). If the determination result is positive (step S9: Yes), the power of the digital camera 1 is turned off, and the process-is terminated. If the determination result is negative (step S9: No), the process is returned to step S1.

What is claimed is:

1. A distance measuring apparatus to be mounted on an imaging device having a strobe emission means for emitting strobe light toward a subject at the time of imaging, and a strobe control means for causing the strobe emission means to perform pre-emission of the strobe light toward the subject prior to imaging, the apparatus comprising:
an obtaining means for obtaining image data of the subject while the pre-emission caused by the strobe control means is performed;
a detection means for detecting a predetermined target object from the image data obtained by the obtaining means;
a determining means for determining whether the luminance and/or gradation of the region of the predetermined target object detected by the detection means is less than or equal to a predetermined threshold value;
an auxiliary light irradiation means for irradiating AF auxiliary light toward the predetermined target object when the luminance and/or gradation of the region of the predetermined target object detected by the detection means is determined by the determination means to be less than or equal to the predetermined threshold value; and
a distance measuring means for measuring the distance to the predetermined target object while the irradiation of AF auxiliary light is performed by the auxiliary light irradiation means.

2. The distance measuring apparatus according to claim 1, wherein the predetermined target object is a face or an eye.

3. The distance measuring apparatus according to claim 2, wherein the auxiliary light irradiation means irradiates the AF auxiliary light toward an area of the face lower than the center or the eyes thereof.

4. A distance measuring method to be employed in an imaging method in which pre-emission of strobe light is performed toward a subject by a strobe emission means prior to imaging, the distance measuring method comprising the steps of:
obtaining image data of the subject while the pre-emission is performed;
detecting a predetermined target object from the obtained image data;
determining whether the luminance and/or gradation of the region of the detected predetermined target object is less than or equal to a predetermined threshold value;
irradiating AF auxiliary light toward the predetermined target object if the luminance and/or gradation of the region of the detected predetermined target object is determined to be less than or equal to the predetermined threshold value; and
measuring the distance to the predetermined target object while the irradiation of AF auxiliary light is performed.
